(19) United States
(12) Patent Application Publication
(10) Pub. No.: US 2021/0344703 A1
(43) Pub. Date: Nov. 4, 2021

(54) Visualized Penetration Testing (VPEN)

(71) Applicant: Booz Allen Hamilton Inc., McLean, VA (US)

(72) Inventors: Michael Joseph BARAJAS, San Antonio, TX (US); Isaac Alexander CORLEY, San Antonio, TX (US)

(73) Assignee: Booz Allen Hamilton Inc., McLean, VA (US)

(21) Appl. No.: 16/864,869

(22) Filed: May 1, 2020

(51) Int. Cl. H04L 29/06; G06F 16/23; G06F 16/22; G06F 16/248

(52) U.S. Cl. CPC H04L 63/1433; G06F 16/2379; G06F 3/0484; G06F 16/248; G06F 16/2246

(57) ABSTRACT

A method is disclosed for enhanced enumeration of network exploits, the method including scanning a network to identify and enumerate vulnerability exploit data from network scan results; accessing a vulnerability database to compare the vulnerability exploit data with stored vulnerability data and, and in response to identifying a match between the vulnerability exploit data and the stored vulnerability data, creating enhanced vulnerability exploit data; organizing the enhanced vulnerability exploit data in a hierarchal tree, table, or other format for display on a computer graphical user interface (GUI) or as input to a computerized system for processing; and updating the vulnerability database with the enhanced vulnerability exploit data.

### FIELD

A method and system, which can be implemented for example as a web application, are disclosed for penetration tester tool sets to visualize and automate enumeration and attacks, and to provide enhanced logging activity to enhance reporting.

### BACKGROUND INFORMATION

There are many challenges in network enumeration tool sets. For example, cyber operators are given outdated network diagrams and only partial information about hosts on their network. Current network enumeration combines data from disparate sources with no central repository to obtain a full point of view of the network and the possible vectors of attack. Known penetration testing tool sets have a clearly defined framework, and much of an early portion of a penetration test involves a cumbersome aggregating of reconnaissance information from a target network. Reviewing extensive results contained in log files can be tedious and difficult to gain insight for an actual plan of attack or defense.

Known tools such as NMAP https://nmap.org/ and Nessus https://www.tenable.com/products/nessus can provide some functionality by bringing attention to network vulnerabilities, but these solutions are only partial, and they require a user to perform additional manual research into exploiting possible misconfigurations and vulnerabilities of a network.

Armitage http://www.fastandeasyhacking.com/ is an open source toolset with added general user interface (GUI) controls and visual functionality but lacks vulnerability enrichment post-network attack scanning; still requiring research by a user to determine which exploits to use for identified vulnerabilities.

Accordingly, there is a need for a more comprehensive system and method which can be implemented as an application-based penetration tester to more fully visualize and automate enumeration and attacks, and exploit such automation to enhance vulnerability enrichment post-network attack scanning with previously unattainable vulnerability insights and reports.

### SUMMARY

A method is disclosed for enhanced enumeration of network exploits, the method including scanning a network to identify and enumerate vulnerability exploit data from network scan results; accessing a vulnerability database to compare the vulnerability exploit data with stored vulnerability data and, and in response to identifying a match between the vulnerability exploit data and the stored vulnerability data, creating enhanced vulnerability exploit data; organizing the enhanced vulnerability exploit data in a hierarchal tree, table, or other format for display on a computer graphical user interface (GUI) or as input to a computerized system for processing; and updating the vulnerability database with the enhanced vulnerability exploit data.

A system is also disclosed for enhanced enumeration of network exploits, the system including a computer having a graphical user interface (GUI) for initiating a network scan to identify and enumerate vulnerability exploit data from network scan results; a database accessible by the computer and containing stored vulnerability data for comparison with the vulnerability exploit data, wherein the computer, upon identifying a match, is configured to create enhanced vulnerability exploit data based on exploits identified during the scan; and a hot server configured to regain access control over a network node identified via the enhanced vulnerability exploit data. A system is also disclosed for enhanced enumeration of network exploits, the system including a computer for initiating a network scan to identify and enumerate vulnerability exploit data from network scan results; a database accessible by the computer and containing stored vulnerability data for comparison with the vulnerability exploit data, wherein the computer, upon identifying a match, is configured to create enhanced vulnerability exploit data based on exploits identified during the scan; and a hot server configured to regain access control over a network node identified via the enhanced vulnerability exploit data.

### BRIEF DESCRIPTION OF THE DRAWINGS

Other objects and advantages of the present disclosure will be realized from the following description of exemplary preferred embodiments when read in conjunction with the drawings set forth herein, wherein:

FIGS. 1a and 1b show an exemplary system backend and a frontend configuration with a computer based graphical user interface (GUI) for enhanced enumeration of network exploits in accordance with the present disclosure, and FIG. 1c shows an exemplary network enumeration displayed on a GUI in accordance with the present disclosure;

FIG. 2 shows an exemplary vulnerability search class functional block diagram;

FIG. 3 is an exemplary database class functional block diagram;

FIG. 4 shows an exemplary database search class functional block diagram;

FIG. 5 shows an exemplary enumerate network class functional block diagram for a class designated “enumerate.py” which enumerates a target network; and

FIG. 6 shows an exemplary flow diagram of an enumeration process implemented by the FIG. 1a, 1b system.

### DETAILED DESCRIPTION

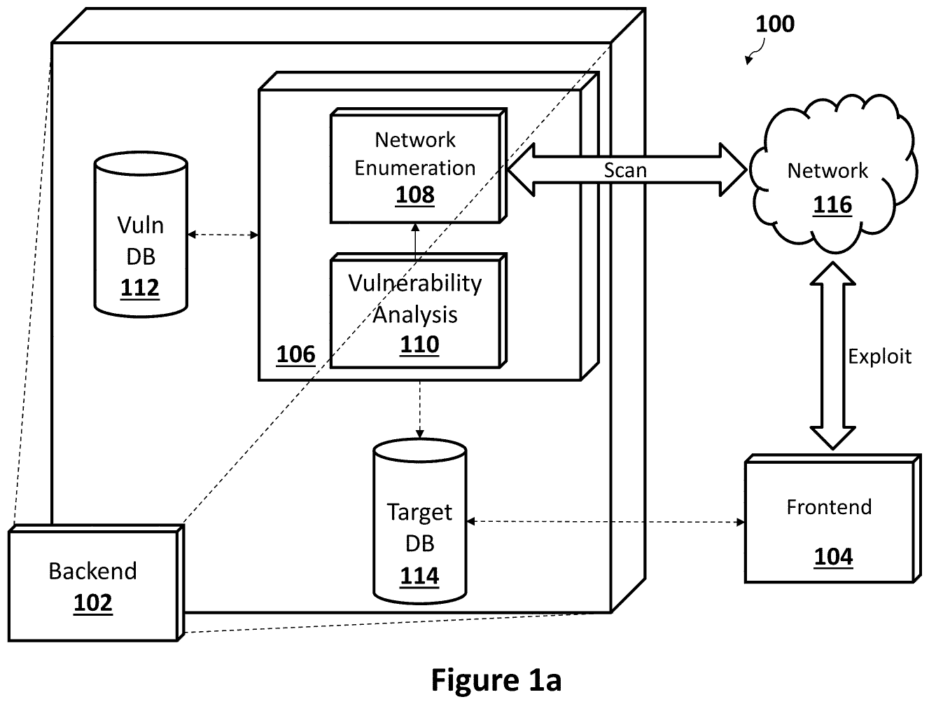

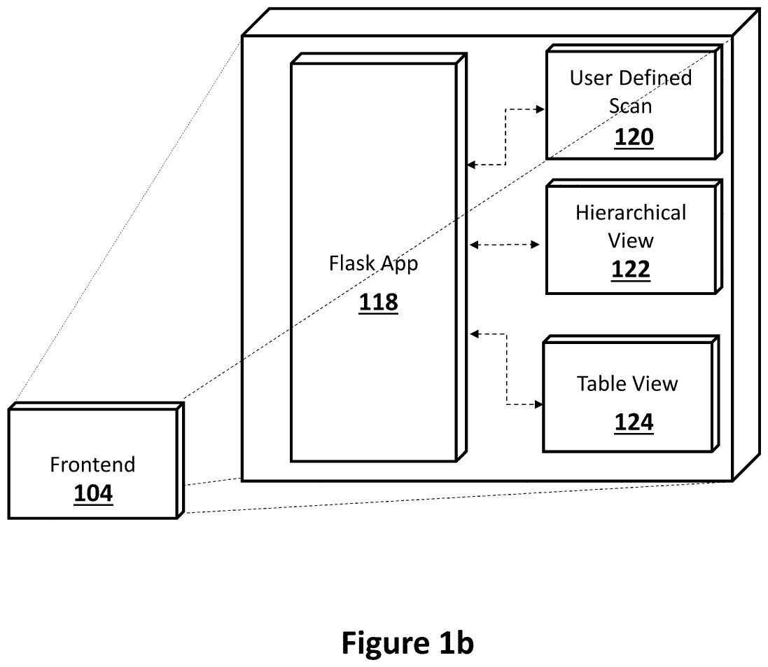

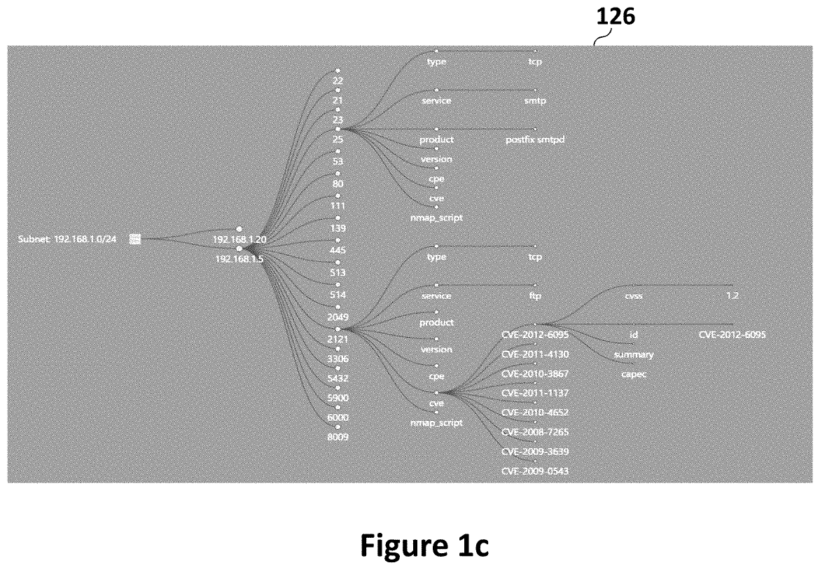

FIG. 1a illustrates an exemplary system 100 for enhanced enumeration of network exploits. The exemplary FIG. 1a system includes a backend 102 and a frontend 104. The backend 102 and the frontend 104 can include a computer configured as one or more processors contained within the backend, the frontend or both the frontend and backend.

The computer can have a graphical user interface (GUI) for a user to initiate a network scan to identify and enumerate vulnerability exploit data from network scan results, and to display results. The computer includes, for example, a processor 106 containing a network enumeration module 108 and a vulnerability analysis module 110.

The graphical user interface can be included in the frontend 104 and can be controlled by a processor located either in the backend 102 or frontend 104.

The FIG. 1a system 100 includes a database, represented as a vulnerability database 112 for storing vulnerability data, and a target database 114 for storing information regarding a target network to be enumerated with regard to vulnerability exploits. The database 112 can be accessible by the computer and can contain stored vulnerability data for comparison with vulnerability exploit data, wherein the computer, upon identifying a match, is configured for creating enhanced vulnerability exploit data based on exploits of a target network identified during the scan.

The FIG. 1a system 100 can include a network 116 having a hot server (i.e., a backup server in a standby mode to take over some or all functionality of a node), the hot server being configured for regaining access control over a network node identified via the enhanced vulnerability exploit data.

In performing network enumeration and vulnerability analysis, a scan of a network 116 is performed using the target database 114 to produce enhanced vulnerability exploit data by comparing scanned vulnerability data with vulnerability data stored in vulnerability database 112. The enhanced vulnerability exploit data can be forwarded to an application of the frontend 104 for hierarchical view 122 as well as an optional table view 124 of the network.

The FIG. 1b system illustrates an exemplary frontend 104 application that includes flask application 118 that can be any known web framework used to build a web application to display scan results in accordance with the present disclosure. The flask application is interfaced with results of a user-defined scan 120 to provide a hierarchical view 122 of the network 116 and/or a table view 124 of the network.

The exemplary FIGS. 1a and 1b system can include a fully automated enumeration/port scanning suite, that can fully ingest prior scan data (e.g., via a Nano XML output). An exemplary automated vulnerability analysis can use a common vulnerability enumeration (CVE) Database (DB) which contains data scraped from, for example, a Nessus scanner (available from Tenable), Metasploit penetration software, CAPEC (common attack penetration pattern enumeration and classification software), Exploit-DB (e.g., which uses CVEs to identify individual vulnerabilities) and so forth, to provide a network visualization framework which can realize a vulnerability map (e.g., a heat map highlighting points of vulnerability such as hosts, nodes or ports) based on a common vulnerability scoring system (CVSS) with scores of respective vulnerabilities (e.g., scores above a threshold defined by the user, or empirically, to call out “hot” spots of vulnerability).

Through an application interface configured in accordance with an exemplary embodiment as disclosed herein, exemplary disclosed penetration testers can run multiple network map (NMAP) scans via a graphical user interface (GUI). Results are then enhanced/enriched with vulnerability data and the network, with attendant hot spots, can be visualized in a hierarchical tree structure.

Results can optionally be returned in a tabular (table) format and applied to any available or desired data filters, whereby the data can be filtered on various parameters to provide enhanced, customized information to a user. If a service listening on an open port has a vulnerability which can be exploited via vulnerability exploitation software, such as proprietary, commercially available Metasploit software of Booz Allen Hamilton, an optional button available on the GUI can be clicked to automatically launch the Metasploit exploit in a computer terminal and return access to a victim host hot server, which can be any designated computer, via a privileged shell.

A database can be included to track all results returned from actions performed in the GUI to assist teams working together, and to timestamp any activity for generation of automated reports. Users have the ability to run any additional vulnerability scans such as the Nikto vulnerability scan tool, which can run automatically if certain applications or open ports are found which correspond to these tools or other tools. Known password/hash cracking tools, such as John the Ripper, or any other such known or to be developed tools, can laterally move throughout the network in a manner apparent to those skilled in the art, and can be included in the FIG. 1a, 1b system.

Evading antivirus tools can also be accomplished, for example, by making custom payloads with Veil or msfvenom, prior to exploiting a given target. Scans can be optionally timestamped and added to the vulnerability database so that scan results can be compared over time to, for example, identify rogue hosts on the network.

FIG. 1c shows an exemplary network enumeration 126 displayed on a GUI in accordance with the present disclosure, wherein the network enumeration 126 shows scan results of the network 116 as a display of hosts, nodes and associated ports (which can be exposed by drilling down on a displayed host or node via the GUI) and wherein hot spots of vulnerability can be highlighted (e.g., color coded).

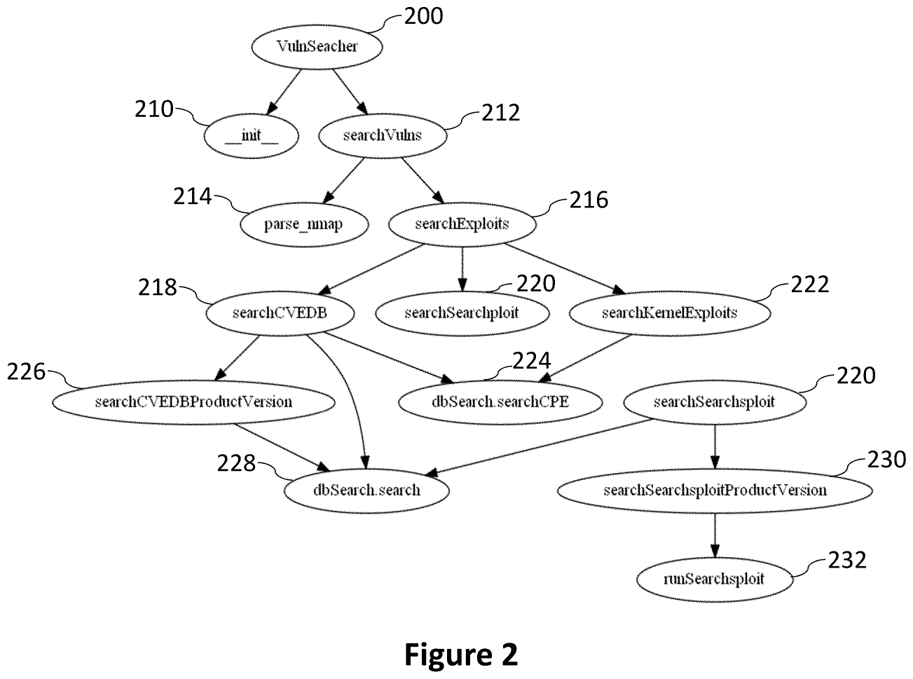

With reference to FIG. 2, an exemplary documentation process can begin with a vulnerability scan, referenced herein as a function call designated vulnerability search, or “vuln_search” (i.e., “VulnSeacher” 200) that queries a CVEDB, conducts searches via searchsploit, and which can be implemented as follows:
1. Welcome To Documentation!
2. vuln_search.py
This Class performs Vulnerability Searching by querying the CVEDB and conducting a search via Searchsploit.

The “VulnSeacher” 200 function call can include an initialization function 210 labeled “_it_”, and a search function 212 labeled “seachVulns.” The SearchVulns function 212 includes an nmap parsing function 214 labeled “parse_nmpa” and an exploit search function 216 labeled “searchExploits.”

The exploit search function 216 includes a CVEBD search function 218 labeled “searchCVEDB”, an exploit search function 220 labeled “searchSearchploit”, and a kernel search function 222 labeled “searchKernelExploits” to identify possible kernel exploits.

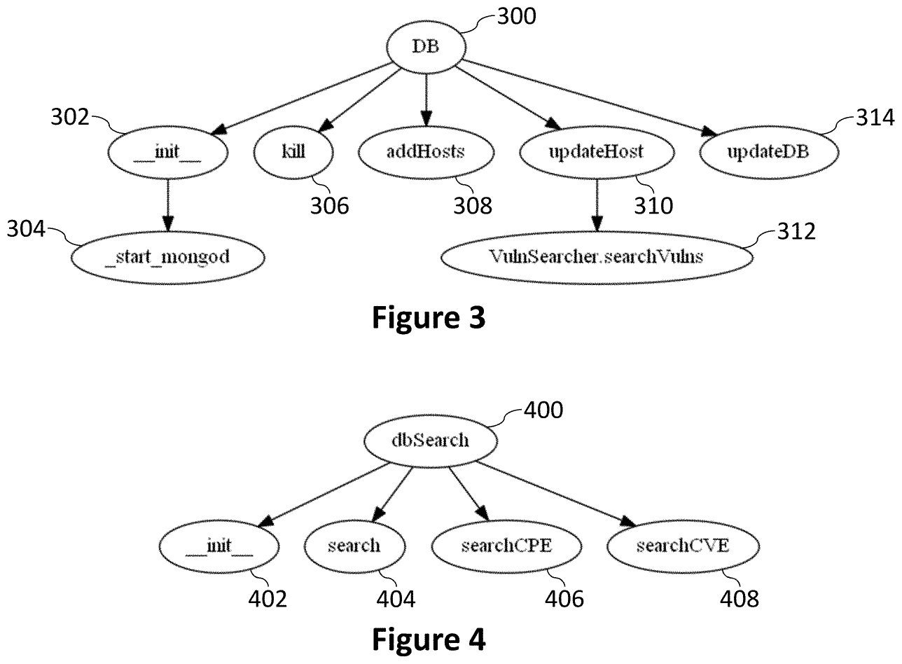

Results of the function blocks 218 and 222 can be used in a database search function block 224 labeled “dbSearch.searchCPE” regarding common platform enumeration (CPE). Product versions can be identified and used to search via function block 226 labeled “searchCVEDBProductVersion” using CVEDB search results. An additional database search function (as will be described with respect to FIGS. 3, 4), using results of the FIG. 2 CVEDB function 218, can then be performed by function block 228 labeled “dbSearch.search.”

The function block 228 can receive results of the search for exploits 220, which results can also be used by the product version search function 230 labeled “searchSearchsploitProductVersion” and used to run the search for exploits in function block 232 labeled “runSearchsploit.”

Exemplary vulnerability search pseudocode associated with an exemplary functional block diagram of FIG. 2 for an exemplary penetration test referred to as “Onslaught” operating on a python-nmap package containing network related files is as follows:

class onslaught.vuln_search.VulnSearcher(db)
Class performs Vulnerability Searching by querying CVEDB and searching results of
Searchsploit

Parse python-nmap package scan in a more standardized and controlled format

```
  host - (dict) Target information of the same format as the ost_template
  dictionary (dict) attribute
```

dict
cl
Returns
Target information of the same format as the host_template dictionary attribute
with all information (except metasploit, exploit, and cve information) populated if
exists in the nmap scan results

Return type

runSearchsploit(product, version)

Execute Searchsploit search given a product and version.

Parameters

product - (str) Product name of a service (e.g. ‘apache_httpd’)
version - (str) Version numbering of a service (e.g. ‘3.0.20-debian’)

Returns

List of Metasploit exploits found

Return
type
List[str]

searchCVEDB(port, info)

Perform logic tree of what to search before searching for exploits via CVEDB

Note: This function will perform text preprocessing using regex

and then execute searchsploit via the runSearchSploit method.

Parameters

port - (str) Port number of the current port being searched (unused)
info - (dict) Port information of the same format as the
port_template dictionary attribute

Returns

List of CVE dicts returned by querying CVEDB

Return
type
List[dict]

search CVEDBProductVersion(product, version)

Search for exploits via CVEDB given a product and version.

Parameters

product - (str) Product name of a service (e.g. ‘apache_httpd’)
version - (str) Version numbering of a service (e.g. ‘3.0.20-debian’)

Returns

List of CVE dicts returned by querying CVEDB

Return
type
List[dict]

searchExploits(target)

```
  Search CVEDB and Searchsploit for CVEs and Metasploit modules for a
  given targets services on open ports
```

Parameters

target - (dict) Target information of the same format as the host_template
dictionary attribute

Returns

```
  Target information of the same format as the host_template dictionary
  attribute
```

with the metasploit, exploit, and searchsploit lists populated with
corresponding exploits if they exist

Return type

dict

searchKernelExploits(cpe)

```
  Searches CVEDB for kernel exploits using the operating system common platform
  enumeration (cpe).
```

Parameters

cpe - (str) CPE of the target operating system (e.g.
‘cpe:/o:linux:linux_kernel:2.6.39’)

Returns

List of Metasploit kernel exploits found

Return
type
List[str]

searchSearchploit(port, info)

```
  Perform logic tree of what to search before searching for exploits via
  Searchsploit
```

Parameters

port - (str) Port number of the current port being searched (unused)
info - (dict) Port information of the same format as the
port_template dictionary attribute

Returns

List of Metasploit exploits found

Return
type
List[str]

searchSearchsploitProductVersion(produrt, version)

Search for exploits via Searchsploit given a product and version.

Note: This function will perform text preprocessing using regex

and then execute searchsploit via the runSearchSploit method.

Parameters

product - (str) Product name of a service (e.g. ‘apache_httpd’)
version - (str) Version numbering of a service (e.g. ‘3.0.20-debian’)

Returns

```
  List of Metasploit exploits found
Return
  type
List[str]
```

searchVulns(host)

Search for vulnerability information of a scanned host nmap results
Parameters

host - (dict) Target information returned by the python-nmap package scans

Returns

Target information of the same format as the host_template dictionary
attribute

with all information populated

Return type

dict

FIG. 3 illustrates exemplary functions associated with a vulnerability database 112, for CVEDB startup (initialization)/shutdown (kill)/updating, and containing classes which interact with CVEDB hosted for example, in MongoDB, for use in identifying network exploits using a scan based on information contained in the target database 114 of FIG. 1a. As illustrated in FIG. 3, exemplary functions include an initialization function 302 labeled “_init_” associated with an exemplary start Mongo DB function 304 labeled “_start_mongod_” (i.e., for an exemplary Mongo configured database). A kill function 306 labeled “kill” can be used to disable a vulnerability exploit (e.g., of a host or node). An add hosts function 308 labeled “addHosts” can be executed to add hosts to the stored network profile. An update host function 310 labeled “updateHost” can be executed, and includes a vulnerability search function 312 labeled “VulnSearcher.searchVulns” whereby host information in the database is updated based on network scan results. An update database function 314 labeled “updateDB” can be executed to perform an asynchronous updating of information stored in the vulnerability database as exploits are identified.

An exemplary vulnerability database 112 which contains classes which interact with a CVEDB hosted in MongoDB, for use in conjunction with the search scan, and which can be updated, can be configured as already described herein with respect to FIG. 3:

Exemplary pseudocode of the designated exemplary “Onslaught” process associated with database management is as follows:

class onslaught.database.DB

Class which handles CVEDB startup/shutdown/updating

addHosts(addresses)

Adds hosts returned from ping sweep with default values

Parameters

addresses - (List[str]) addresses to create default host templates
for and add to hosts collection

Returns

None

kill(drop_hosts=True)

Close mongod when finished

Parameters

drop_hosts - (bool) if True drop the hosts collection, otherwise don't

Returns

None

```
  updateDB(filename=‘cvedb.json’, base_url=‘http:
  /cve.circl.lu/static/circl-cve-search-expanded.json.gz’,
  chunk_size=512000)
```

Download latest cve db
Parameters

filename - (str) output filename of the json file
base_url - (str) base url to the database
chunk_size - (int) size in bytes to download in chunks

Returns

None

updateHost(address, scan)

Updates host record in database after port scan

Parameters

address - (str) address of the target to update in the hosts
collection
scan - (dict) populated host template after vulnerability scan

Returns

None

FIG. 4 illustrates exemplary function calls associated with a database search function 400 labeled “dbSearch” for searching the target database to identify vulnerabilities using the vulnerability database. These function calls can include a start (initialization) function 402 labeled “_init_”, a search function 404 labeled “search”, a search CPE (common product enumeration) function 406 labeled “searchCPE,” and a search CVE (common vulnerability enumeration) function 406 labeled “searchCVE.” The FIG. 4 database search class functional block diagram includes exemplary function calls as discussed, but can of course, include any additional function calls desired by the user to elicit enhanced vulnerability data that can be enumerated for identification and/or display of network vulnerabilities.

As regards the FIG. 4 exemplary database search class functional block diagram, exemplary pseudocode for executing a search of the CVEDB is as follows:

class onslaught.databse.dbSearch(collection, timeout_ms)

Class which performs searching of CVEDB

search(product, version)

Search for a CVE given a product and version

Parameters

product - (str) Product name of a service (e.g. ‘apahce_httpd’)
version - (str) Version numbering of a service (e.g. ‘3.0.20-debian’)

Returns

resulting information of the given query

Return type

dict

searchCPE(cpe)

Search for a CVE that matches a given CPE. CPE must contain
product/vendor/version

Parameters

cpe - (str) CPE of the target operating system (e.g.
‘cpe:/o:linux:linux_kernel:2.6.39’)

Returns

resulting information of the given query

Return type

dict

searchCVE(cve)

Search for information regarding a specified CVE

Parameters

cve - (str) CVE id (e.g. CVE-2015-0945)

Returns

resulting information of the given query

Return type
dict

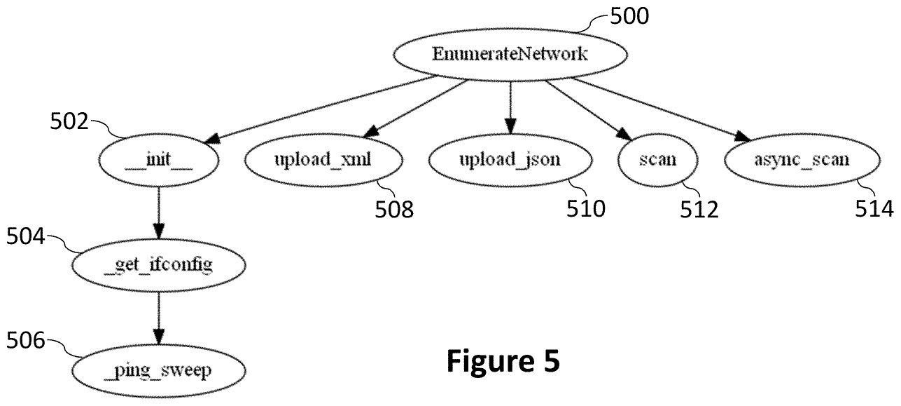

FIG. 5 illustrates an exemplary “EnumerateNetwork” class functional block diagram. In FIG. 5, the EnumerateNetwork class 500 includes an initialization function 502 labeled “_init_”, a get interface configuration function 504 labeled “_get_ifconfig” regarding an interface configuration, and a ping function 506 labeled “_ping_sweep” for performing a network sweep based on information in the target network database as described herein. An upload function 508 labeled “upload_xml” (e.g., XML format), and an upload function 510 labeled “upload_ison” (e.g., JSON) are also included. The EnumerateNetwork class includes a scan function 512 labeled “scan” and an asynchronous scan function 514 labeled “async_scan” for performing network scans.

The FIG. 5 EnumerateNetwork class can be executed by a network enumeration tool (NET), which can include an exemplary “red team” (adversarial attack) and “blue team” (network defense) to enhance the elicited vulnerability data acquired from the target network (e.g., IP addresses, device ports, and so forth) as follows:
RED (ATTACK) TEAM
Provide further service/host enumeration (e.g., SQLMap, Hydra, John)
Automated attack capabilities (e.g., Metasploit, PowerShell Empire)
BLUE (DEFENSE) Team
Provide further Threat Hunting Capabilities (e.g., TCP analysis)
Provide mitigation and solution information for vulnerabilities contained in the database
A vulnerability analysis output report (e.g., PDF and JSON) can be provided via a computer based graphical user interface (GUI), as illustrated in FIG. 1 and used to update the vulnerability database, and the network hot spots.

FIG. 5 shows that an exemplary enumerate network class functional block diagram, for a class designated “enumerate.py”, will enumerate exploits associated with a target network. Exemplary pseudocode for this function is as follows:

class onslaught.enumerate.EnumerateNetwork(args=None, adopter=‘eth0’,
udp=False, ignore=None)

Enumerate the current network or a specific target ip

async_scan(callback, targets=None)

Perform asynchronous nmap scan
callback - (func) callback function to be called after each port scan is
completed
targets - (List[str]) optional list of IP addresses to scan, otherwise scans hosts
found during ping sweep
Returns

None

scan(targets=None, callback=None)

Perform synchronous nmap scan
Parameters
targets - (List[str]) optional list of IP addresses to scan, otherwise scans hosts found
during ping sweep
callback - (func) op_onal callback func_on to be called a er each port scan is
completed

Returns

None

Upload_json(file-path)

```
Upload previous scan results json file and parse hosts
Parameters
  file_path - (str) file path to json output of a previously executed scan
Returns
  None
```

upload_xml(file_path)

Upload nmap xml file and parse hosts
Parameters

file_path - (str) file path to xml ouput of an externally fun nmap scan

Returns

None

Exemplary indices and tables can be described as follows:

Indices and tables

Index

Module Index

Search Page

Thus, using the enumeration function of FIG. 5, network exploits can be identified in a robust, comprehensive manner, for enhanced network management and security to update a vulnerability database and to provide network vulnerability for a target network to a user via a GUI. Nodes deemed venerable can, for example, be bypassed and their functionality executed by a hot server associated with the FIG. 1a network 116 until the vulnerability can be neutralized/eliminated though elimination of the exploit threat.

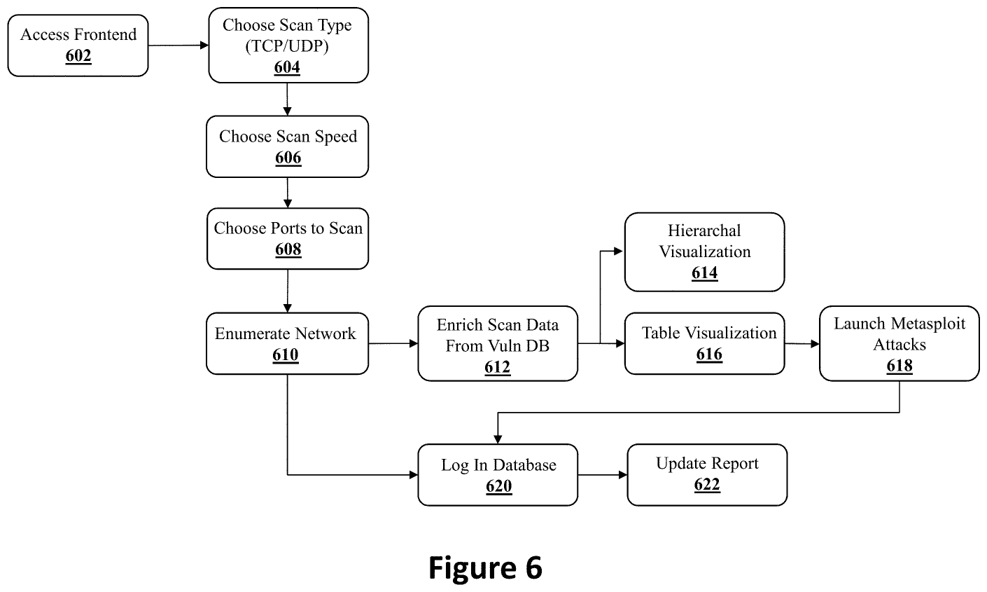

FIG. 6 shows an exemplary flow diagram of an enumeration process 600 implemented by the FIG. 1a, 1b system. The enumeration process 600 can initially access the FIG. 1a frontend application 104 in the FIG. 6 step 602. A user then chooses a scan type (e.g., TCP/UDP) in step 604. The process 600 can include an optional step 606 to choose a scan speed, and to choose ports to scan in step 608.

Network enumeration is executed in step 610, and scan results used in conjunction with the enumeration can be used to enrich scan data in step 612 based an access to the FIG. 1a vulnerability database 112. Using the enriched scan data, a hierarchical visualization 614 and/or a table visualization 616 of the target network 116 can be rendered via display components 122, 124 of the FIG. 1b frontend GUI as, for example, the displayed network of FIG. 1c.

To further enhance data enrichment, Metasploit (Red Team) attacks can be launched in step 618, and the database login of step 620 can be invoked to update the database with network enumeration scan data and information acquired in response to the Metasploit attacks. An update report can be produced in step 622 for access by a user via the GUI of the FIG. 1a frontend.

A person having ordinary ski in the art would appreciate that embodiments of the disclosed subject matter, such as the system of FIGS. 1a, 1b, can be practiced with various computer system configurations, including multi-core multiprocessor systems, minicomputers, mainframe computers, computers linked or clustered with distributed functions, as well as pervasive or miniature computers that can be embedded into virtually any device. For instance, one or more of the disclosed modules can be a hardware processor device with an associated memory.

A hardware processor device as discussed herein can be a single hardware processor, a plurality of hardware processors, or combinations thereof. Hardware processor devices can have one or more processor “cores.” The term “non-transitory computer readable medium” as discussed herein is used to generally refer to tangible media such as a memory device.

Various embodiments of the present disclosure are described in terms of an exemplary computing device. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment and with program code stored locally or remotely for access by singe or multi-processor machines. In addition, in some embodiments the order of operations can be rearranged without departing from the spirit of the disclosed subject matter.

A hardware processor, as used herein, can be a special purpose or a general purpose processor device. The hardware processor device can be connected to a communications infrastructure, such as a bus, message queue, network, multi-core message-passing scheme, etc. An exemplary computing device, as used herein, can also include a memory (e.g., random access memory, read-only memory, etc.), and can also include one or more additional memories. The memory and the one or more additional memories can be read from and/or written to in a well-known manner. In an embodiment, the memory and the one or more additional memories can be non-transitory computer readable recording media.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or sold-state drive. An operating system can be stored in the memory.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc.

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer program stored on a non-transitory computer-readable medium, when executed, can enable hardware processor device to implement the methods discussed herein. Accordingly, such computer programs can represent controllers of the computing device.

Where the present disclosure is implemented using software, the software can be stored in a computer program product or non-transitory computer readable medium and loaded into the computing device using a removable storage drive or communications interface. In an exemplary embodiment, any computing device disclosed herein can also include a display interface that outputs display signals to a display unit, e.g., LCD screen, plasma screen, LED screen, DLP screen, CRT screen, etc.

It wig be appreciated by those skilled in the art that the present invention can be embodied in other specific forms without departing from the spirit or essential characteristics thereof. The presently disclosed embodiments are therefore considered in al respects to be illustrative and not restricted. The scope of the invention is indicated by the appended claims rather than the foregoing description and all changes that come within the meaning and range and equivalence thereof are intended to be embraced therein.

What is claimed is:

1. A method for enhanced enumeration of network exploits, the method comprising:
scanning a network to identify and enumerate vulnerability exploit data from network scan results;
accessing a vulnerability database to compare the vulnerability exploit data with stored vulnerability data;
in response to identifying a match between the vulnerability exploit data and the stored vulnerability data, creating enhanced vulnerability exploit data;
organizing the enhanced vulnerability exploit data for display on a computer graphical user interface (GUI); and
updating the vulnerability database with the enhanced vulnerability exploit data.

2. The method according to claim 1, wherein the enhanced vulnerability exploit data is organized in a hierarchal tree structure.

3. The method according to claim 1, wherein the enhanced vulnerability exploit data is organized in a table.

4. The method according to claim 1, comprising:
returning access control over a node from an exploit to a host server of the network, the node being identified using the enhanced vulnerability exploit data.

5. The method according to claim 4, wherein returning access control over a node from an exploit to a host server of the network is initiated via a button on the GUI.

6. The method according to claim 1, comprising:
filtering the vulnerability exploit data.

7. The method according to claim 1, wherein scanning a network to identify and enumerate vulnerability exploit data from network scan results initiated via the GUI.

8. A system for enhanced enumeration of network exploits, the system comprising:
a computer having a graphical user interface (GUI) for initiating a network scan to identify and enumerate vulnerability exploit data from network scan results;
a database accessible by the computer and containing stored vulnerability data for comparison with the vulnerability exploit data, wherein the computer, upon identifying a match, is configured for creating enhanced vulnerability exploit data based on exploits identified during the scan; and
a hot server configured for regaining access control over a network node identified via the enhanced vulnerability exploit data.

9. The system according to claim 8, wherein the GUI is configured to display the enhanced vulnerability data.

10. The system according to claim 9, wherein the enhanced vulnerability data is displayed as a hierarchal tree structure.

11. The system according to claim 9, wherein the enhanced vulnerability data is displayed as a table.

12. The system according to claim 8, wherein the computer is configured to filter the vulnerability exploit data.

13. A system for enhanced enumeration of network exploits, the system comprising:
a computer for initiating a network scan to identify and enumerate vulnerability exploit data from network scan results;
a database accessible by the computer and containing stored vulnerability data for comparison with the vulnerability exploit data, wherein the computer, upon identifying a match, is configured for creating enhanced vulnerability exploit data based on exploits identified during the scan; and
a hot server configured for regaining access control over a network node identified via the enhanced vulnerability exploit data.
